(19) United States
(12) Patent Application Publication
(10) Pub. No.: US 2024/0410277 A1
(43) Pub. Date: Dec. 12, 2024

(54) Method for determining production shares of free gas and adsorbed gas in deep coalbed methane well mining

(71) Applicant: Exploration & Production Research Institute of SINOPEC North-China Oil & Gas Company, Zhengzhou city (CN)

(72) Inventors: Bo Hu, Zhengzhou city (CN); Yongyi Zhou, Zhengzhou city (CN); Kui Chen, Zhengzhou city (CN); Linsong Liu, Zhengzhou city (CN); Tongsheng Cao, Zhengzhou city (CN); Yaonan Yu, Zhengzhou city (CN); Yongheng Wang, Zhengzhou city (CN)

(21) Appl. No.: 18/810,507

(22) Filed: Aug. 21, 2024

(30) Foreign Application Priority Data
Nov. 3, 2023 (CN) 202311456257.3

(51) Int. Cl. E21B 49/00; E21B 43/00

(52) U.S. Cl. CPC E21B 49/00; E21B 43/006

(57) ABSTRACT

A method for determining production shares of free gas and adsorbed gas in deep coalbed methane well mining includes steps of: collecting an original formation pressure and PVT sampling experimental analysis data of a coalbed methane well to obtain deviation factors; collecting isothermal adsorption experimental data as well as adsorbed gas content and free gas content under the original formation pressure and the temperature conditions; determining a Langmuir pressure and a Langmuir volume based on the isothermal adsorption experimental data; determining daily production of the free gas and the adsorbed gas, determining a coalbed methane recovery percent, and determining production shares of the free gas and the adsorbed gas under any formation pressure; and obtaining the production shares of the free gas and the adsorbed gas under different recovery percent. The method is simple, easy to understand and implement.

### CROSS REFERENCE OF RELATED APPLICATION

The present invention claims priority under 35 U.S.C. 119(a-d) to CN 202311456257.3, filed Nov. 3, 2023.

### BACKGROUND OF THE PRESENT INVENTION

### Field of Invention

The present invention relates to development research of oil and gas fields, and more particularly to a method for determining production shares of free gas and adsorbed gas in deep coalbed methane well mining.

### Description of Related Arts

Both indoor experiments and production practices show that free gas and adsorbed gas coexist in deep coal rocks. How to determine the production shares of free gas and adsorbed gas in deep coalbed methane wells can affect the optimization of coalbed methane development technology policy, the prediction of development indexes, and the evaluation of development effect, thus having a very important field application value. Conventional method for determining the production shares of free gas and adsorbed gas in deep coalbed methane mining can be found in Chinese patent CN115860266A, a shale gas/coalbed methane well production evaluation method, system and electronic equipment, which relates to a technical field of shale gas/coalbed methane production evaluation. The method comprises: establishing a simulation model of a target horizontal well based on reservoir parameters as well as drilling and completing parameters of the target well; constructing a set of control equations and their corresponding initial conditions and boundary conditions based on the above model, and solving the set of control equations under the initial conditions and boundary conditions to compute productivity evaluation parameters of the target well in the production process; fitting the measured productivity evaluation parameters with the computed productivity evaluation parameters, using the key parameters and productivity evaluation parameters corresponding to the optimal fitting results as the optimal key parameters and final productivity evaluation parameters for the target well in the production process, respectively. The disclosure shows that it can accurately obtain the final recoverable reserves, the ratio of adsorbed gas/free gas in daily gas production, the fracture inflow capacity, the matrix diffusion coefficient and the adsorption capacity of shale gas/coalbed methane wells. However, although it can realize the productivity determination of shale gas/coalbed methane well, the obtaining steps are complicated, making it hard to be popularized. Therefore, there is an urgent need to propose a method to determine production shares of free gas and adsorbed gas in deep coalbed methane wells.

### SUMMARY OF THE PRESENT INVENTION

An object of the present invention is to provide a method for determining production shares of free gas and adsorbed gas in deep coalbed methane well mining, which is intended to solve the technical problem that conventional method for obtaining the production shares of free gas and adsorbed gas is complicated and hard to be popularized.

Accordingly, in order to accomplish the above objects, the present invention provides a method for determining production shares of free gas and adsorbed gas in deep coalbed methane well mining, comprising steps of:
Step 1: collecting an original formation pressure Pᵢ and PVT sampling experimental analysis data of a target coalbed methane well, so as to obtain deviation factors corresponding to different pressures under coalbed methane well formation temperature conditions;
Step 2: collecting isothermal adsorption experimental data carried out on deep coal rocks, as well as adsorbed gas content G₀ₐ and free gas content G_{0f} under the original formation pressure and the temperature conditions;
Step 3: determining a Langmuir pressure P_{L} and a Langmuir volume V_{L} based on the isothermal adsorption experimental data;
Step 4: determining a daily production Q_{fp} of the free gas when the formation pressure is P;
Step 5: determining a daily production Qₐₚ of the adsorbed gas when the formation pressure is P;
Step 6: determining a coalbed methane recovery percent R_{P} when the formation pressure is P;
Step 7: based on the daily production Q_{fp} of the free gas obtained in the Step 4 when the formation pressure is P and the daily production Qₐₚ of the adsorbed gas obtained in the Step 5 when the formation pressure is P, calculating a production share Q_{fp}/(Q_{fp}+Qₐₚ) of the free gas when the formation pressure is P as well as a production share Qₐₚ/(Q_{fp}+Qₐₚ) of the adsorbed gas when the formation pressure is P;
Step 8: obtaining different formation pressures P, and repeating the Steps 1-7, thereby obtaining the production shares of the free gas and the adsorbed gas under the different formation pressures; and
Step 9: based on the production shares of the free gas and the adsorbed gas under the different formation pressures obtained in the Step 8, as well as the coalbed methane recovery percent R_{P} obtained in the Step 6 when the formation pressure is P, obtaining the production shares of the free gas and the adsorbed gas under different recoveries.

Preferably, in the Step 3, the Langmuir pressure P_{L} and the Langmuir volume V_{L} are determined by steps of:
introducing

$${y}_{( i )} = \frac{1}{{V}_{g ( i )}}$$

and x₍ᵢ₎=P₍ᵢ₎, i=1,2, . . . , n; according to adsorption gas volumes V_{g(1)}, V_{g(2)}, . . . , V_{g(n)} corresponding to the different pressures P₍₁₎, P₍₂₎, . . . , P₍ₙ₎ under the coalbed methane well formation temperature conditions, obtaining a series of observation points (y₍ᵢ₎, x₍ᵢ₎); and processing the observation points with linear fit, wherein the Langmuir volume V_{L} is equal to an inverse of an intercept of a fitted linear equation, and the Langmuir pressure P_{L} is equal to a slope of the fitted linear equation divided by the intercept of the fitted linear equation.

Preferably, in the Step 4, the daily production Q_{fp} of the free gas when the formation pressure is P is obtained by steps of:
based on the PVT sampling experimental analysis data obtained in the Step 1, using a model R_{fp}=1−(P/Z)/(Pᵢ/Zᵢ) to determine a free gas recovery percent R_{fp1} when the formation pressure is P+ΔP and a free gas recovery percent R_{fp2} when the formation pressure is P−ΔP; and assuming the formation pressure drops from P+ΔP down to P−ΔP in T days, then a cumulative free gas production of the coalbed methane well after the T days is G_{0f}*(R_{fp2}−R_{fp1}), and an average daily free gas production of the coalbed methane well during the T days is Q_{fp}=G_{0f}*(R_{fp2}−R_{fp1})/T; wherein Q_{fp} is defined as the daily free gas production when the formation pressure is P if ΔP is sufficiently small.

Preferably, in the Step 5, the daily production Qₐₚ of the adsorbed gas when the formation pressure is P is obtained by steps of:
based on the Langmuir pressure P_{L} and the Langmuir volume V_{L} obtained in the Step 3, using a model Rₐₚ=1−(P/Pᵢ)*(Pᵢ+P_{L})/(P_{L}+P_{L}) to determine an adsorbed gas recovery percent Rₐₚ₁ when the formation pressure is P+ΔP and an adsorbed gas recovery percent Rₐₚ₂ when the formation pressure is P−ΔP; and
assuming the formation pressure drops from P+ΔP down to P−ΔP in T days, then a cumulative adsorbed gas production of the coalbed methane well after the T days is G₀ₐ*(Rₐₚ₂−Rₐₚ₁), and an average daily adsorbed gas production of the coalbed methane well during the T days is Qₐₚ=G₀ₐ*(Ra₂−Rₐ₁)/T; wherein Qₐₚ is defined as the daily adsorbed gas production when the formation pressure is P if ΔP is sufficiently small.

Preferably, in the Step 6, the coalbed methane recovery percent R_{P} when the formation pressure is P is obtained by steps of:
based on the PVT sampling experimental analysis data obtained in the Step 1, using a model R_{fp}=1−(P/Z)/(Pᵢ/Zᵢ) to determine a free gas recovery percent R_{fp1} when the formation pressure is P; based on the free gas content G_{0f} obtained in the Step 2 under the original formation pressure and the temperature conditions, obtaining a cumulative free gas production G_{0f}×R_{fP} when the formation pressure is P; and based on the Langmuir pressure P_{L} and the Langmuir volume V_{L} obtained in the Step 3, using a model Rₐₚ=1−(P/Pᵢ)*(Pᵢ+P_{L})/(P_{L}+P_{L}) to determine an adsorbed gas recovery percent Rₐₚ when the formation pressure is P; based on the adsorbed gas content G₀ₐ obtained in the Step 2 under the original formation pressure and the temperature conditions, obtaining a cumulative adsorbed gas production G₀ₐ×Rₐₚ when the formation pressure is P; wherein when the formation pressure is P, a total production of the free gas and the adsorbed gas is G_{0f}×R_{fP}+G₀ₐ×Rₐₚ, then the coalbed methane recovery percent R_{P} when the formation pressure is P is calculated as R_{P}=(G_{0f}×R_{fP}+G₀ₐ×Rₐₚ)/(G_{0f}+G₀ₐ), equaling to

$${R}_{P} = \frac{{G}_{0 f} * ( 1 - \frac{P {Z}_{i}}{{P}_{i} Z} ) + {G}_{0 a} * ( 1 \frac{P}{{P}_{i}} \times \frac{{P}_{i} + {P}_{L}}{P + {P}_{L}} )}{{G}_{0 a} + {G}_{0 f}} .$$

### Beneficial Effects

(1) The method of the present invention is simple, easy to understand and implement, has strong operability, is effective and practical, and has good promotion and use value.
(2) The production share data of free gas and adsorbed gas during the coalbed methane well mining can be used for the optimization of coalbed methane well development technology policy, the prediction of development indexes, and the evaluation of the mining effect and development benefits, thus having a very important field application value.

### BRIEF DESCRIPTION OF THE DRAWINGS

FIG. 1 is a flow chart of a method for determining production shares of free gas and adsorbed gas in deep coalbed methane well mining of the present invention;

FIG. 2 is a fitted plot of deviation factor as a function of pressure; and

FIG. 3 is a linear fit plot of observation point data during determination of Langmuir pressure and Langmuir volume.

### DETAILED DESCRIPTION OF THE PREFERRED EMBODIMENT

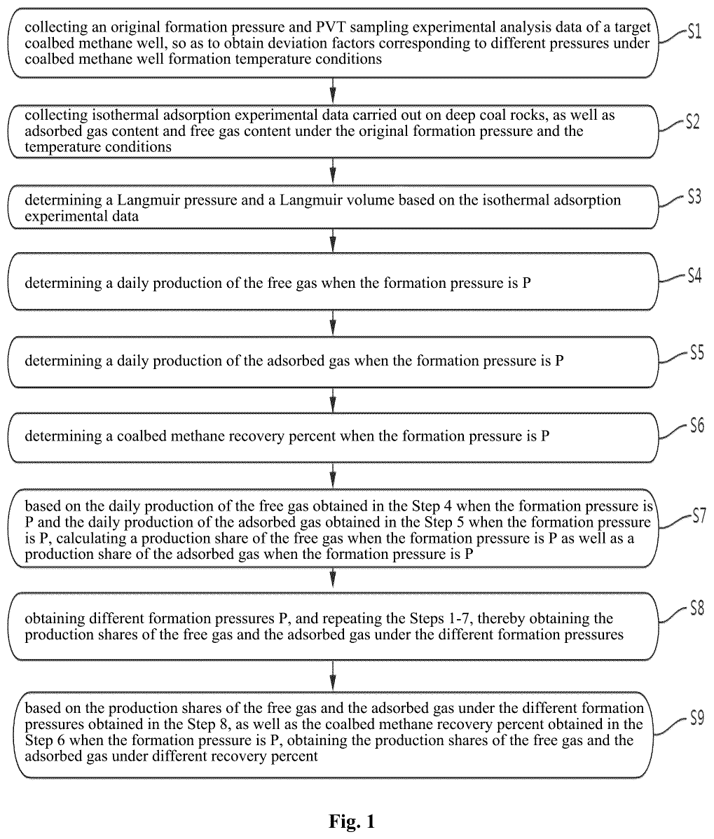

Referring to FIG. 1, the present invention provides a method for determining production shares of free gas and adsorbed gas in deep coalbed methane well mining, comprising steps of:
Step 1: collecting an original formation pressure Pᵢ and PVT sampling experimental analysis data of a target coalbed methane well, so as to obtain deviation factors corresponding to different pressures under coalbed methane well formation temperature conditions; and establishing a pressure-based deviation factor expression z=f(P) by function fitting;
Step 2: collecting isothermal adsorption experimental data carried out on deep coal rocks, as well as adsorbed gas content G₀ₐ and free gas content G_{0f} under the original formation pressure and the temperature conditions;
Step 3: introducing

$${y}_{( i )} = \frac{1}{{V}_{g ( i )}}$$

and x₍ᵢ₎=P₍ᵢ₎, i=1,2, . . . , n; according to adsorption gas volumes V_{g(i)}, V_{g(2)}, . . . , V_{g(n)} corresponding to the different pressures P₍ᵢ₎, P₍₂₎, . . . , P₍ₙ₎ under the coalbed methane well formation temperature conditions, obtaining a series of observation points (y₍ᵢ₎, x₍ᵢ₎); and processing the observation points with linear fit, wherein the Langmuir volume V_{L} is equal to an inverse of an intercept of a fitted linear equation, and the Langmuir pressure P_{L} is equal to a slope of the fitted linear equation divided by the intercept of the fitted linear equation;
Step 4: based on the PVT sampling experimental analysis data obtained in the Step 1, determining a sufficiently small pressure change ΔP of the formation pressure P;
specifically, based on the deviation factor expression z=f(P) obtained in the Step 1, calculating a deviation factor Zᵢ corresponding to the original formation pressure Pᵢ, a deviation factor Z₁ corresponding to a formation pressure P+ΔP, and a deviation factor Z₂ corresponding to a formation pressure P−ΔP; using a model R_{fP}=1−(P/Z)/(Pᵢ/Zᵢ) to determine a free gas recovery percent R_{fp1}=1−((P+ΔP)/Z₁)/(Pᵢ/Zᵢ) when the formation pressure is P+ΔP and a free gas recovery percent R_{fp2}=1−((P−ΔP)/Z₂)/(Pᵢ/Zᵢ) when the formation pressure is P−ΔP;
assuming the formation pressure drops from P+ΔP down to P−ΔP in T days, then a cumulative free gas production of the coalbed methane well after the T days is G_{0f}*(R_{fp2}−R_{fp1}), and an average daily free gas production of the coalbed methane well during the T days is Q_{fp}=G_{0f}*(R_{fp2}−R_{fp1})/T; wherein Q_{fp} is defined as the daily free gas production when the formation pressure is P if ΔP is sufficiently small;
Step 5: based on the Langmuir pressure P_{L} and the Langmuir volume V_{L} obtained in the Step 3, using a model Rₐₚ−1−(P/Pᵢ)*(Pᵢ+P_{L})/(P_{L}+P_{L}) to determine an adsorbed gas recovery percent Rₐₚ₁−1−[(P+ΔP)/Pᵢ]*(Pᵢ+P_{L})/[(P+ΔP)+P_{L}] when the formation pressure is P+ΔP and an adsorbed gas recovery percent Rₐₚ₂−1−[(P−ΔP)/Pᵢ]*(Pᵢ+P_{L})/[(P−ΔP)+P_{L}] when the formation pressure is P−ΔP; and
assuming the formation pressure drops from P+ΔP down to P−ΔP in T days, then a cumulative adsorbed gas production of the coalbed methane well after the T days is G₀ₐ*(Rₐₚ₂−Rₐₚ₁), and an average daily adsorbed gas production of the coalbed methane well during the T days is Qₐₚ=G₀ₐ*(Ra₂−Rₐ₁)/T; wherein Qₐₚ is defined as the daily adsorbed gas production when the formation pressure is P if ΔP is sufficiently small;
Step 6: based on the original formation pressure Pᵢ and the PVT sampling experimental analysis data obtained in the Step 1, calculating a deviation factor Z corresponding to the original formation pressure P based on the deviation factor expression z=f(P) obtained in the Step 1; according to the free gas content G_{0f} and the adsorbed gas content G₀ₐ obtained in the Step 2 under the original formation pressure and the temperature conditions, the Langmuir pressure P_{L} obtained in the Step 3, and the deviation factor Zᵢ corresponding to the original formation pressure Pᵢ obtained in the Step 4; using a model

$${R}_{P} = \frac{{G}_{0 f} * ( 1 - \frac{P {Z}_{i}}{{P}_{i} Z} ) + {G}_{0 a} * ( 1 \frac{P}{{P}_{i}} \times \frac{{P}_{i} + {P}_{L}}{P + {P}_{L}} )}{{G}_{0 a} + {G}_{0 f}} .$$

to determine the coalbed methane recovery percent R_{P} when the formation pressure is P;
Step 7: based on the daily production Q_{fp} of the free gas obtained in the Step 4 when the formation pressure is P and the daily production Qₐₚ of the adsorbed gas obtained in the Step 5 when the formation pressure is P, calculating a production share Q_{fp}/(Q_{fp}+Qₐₚ) of the free gas when the formation pressure is P as well as a production share Qₐₚ/(Q_{fp}+Qₐₚ) of the adsorbed gas when the formation pressure is P;
Step 8: obtaining different formation pressures P, and repeating the Steps 1−7, thereby obtaining the production shares of the free gas and the adsorbed gas under the different formation pressures; and
Step 9: based on the production shares of the free gas and the adsorbed gas under the different formation pressures obtained in the Step 8, as well as the coalbed methane recovery percent R_{P} obtained in the Step 6 when the formation pressure is P, obtaining the production shares of the free gas and the adsorbed gas under different recoveries.

The embodiment obtains the deviation factor corresponding to different pressures under coalbed methane formation temperature conditions by collecting the original formation pressure and PVT sampling experimental analysis data of the coalbed methane well; collects the isothermal adsorption experimental data carried out on deep coal rocks, as well as adsorbed gas content and free gas content under the original formation pressure and the temperature conditions; determines a Langmuir pressure and a Langmuir volume based on the isothermal adsorption experimental data; determines the daily production of the free gas and the adsorbed gas under any formation pressure; determines the coalbed methane recovery percent under any formation pressure; and determines the production shares of the free gas and the adsorbed gas under any formation pressure. After collecting different formation pressures, the above method can obtain the production shares of the free gas and the adsorbed gas under different formation pressures. According to the production shares of the free gas and the adsorbed gas under different formation pressures, the production shares of the free gas and the adsorbed gas under different recovery percent can be obtained based on the coalbed methane recovery percent corresponding to different formation pressures. The method of the present invention is simple, easy to understand and implement, has strong operability, is effective and practical, and has good promotion and use value.

Preferably, in the Step 3, the Langmuir pressure P_{L} and the Langmuir volume V_{L} are determined in accordance with the following rationale:
the isothermal adsorption equation for coalbed methane is:

$${V}_{g} = \frac{{V}_{L} * P}{P + {P}_{L}} \qquad ( 1 )$$

taking the inverse of both ends of equation (1):

$$\frac{1}{{V}_{g}} = \frac{P + {P}_{L}}{{V}_{L} * P} \qquad ( 2 )$$

from equation (2):

$$\frac{1}{{V}_{g}} = \frac{1}{{V}_{L}} + \frac{{P}_{L}}{{V}_{L}} \frac{1}{* P} \qquad ( 3 )$$

$$making$$

$${y}_{( i )} = \frac{1}{{V}_{g ( i )}} \qquad ( 4 )$$

$${x}_{( i )} = \frac{1}{{P}_{( i )}} \qquad ( 5 )$$

wherein i is an isothermal adsorption experimental data point number, and i=1,2, . . . , n; V_{g(i)} is an adsorbed gas volume of the i-th experimental data point, m³/t; P₍ᵢ₎ is a pressure of the i-th experimental data point, MPa; V_{L} is the Langmuir volume, m³/t; P_{L} is the Langmuir pressure, MPa.

According to the isothermal adsorption experimental data of different pressures P₍₁₎, P₍₂₎, . . . , P₍ₙ₎, the corresponding adsorbed gas volumes are V_{g(1)}, V_{g(2)}, . . . , V_{g(n)}. A series of observation points (y₍ᵢ₎, x₍ᵢ₎) can be obtained from the equations (4) and (5). After linear fitting of the above observation point data, it can be seen from the equation (3) that the Langmuir volume V_{L} is equal to an inverse of an intercept of a fitted linear equation, and the Langmuir pressure P_{L} is equal to a slope of the fitted linear equation divided by the intercept of the fitted linear equation.

Preferably, principles for determining the coalbed methane recovery percent under any formation pressure conditions are as follows:
according to the equation (1), the isothermal adsorption equation of coalbed methane well, the adsorbed gas volume V_{gi} under the original formation pressure Pᵢ can be obtained:

$${V}_{g i} = \frac{{V}_{L} * {P}_{i}}{{P}_{i} + {P}_{L}} \qquad ( 6 )$$

the adsorbed gas volume at any formation pressure P is

$${V}_{g} = \frac{{V}_{L} * P}{P + {P}_{L}} ,$$

and thus the cumulative adsorbed gas production Gₚₐ under the formation pressure P is:

$${G}_{p a} = {V}_{g i} - {V}_{g} = \frac{{V}_{L} * {P}_{i}}{{P}_{i} + {P}_{L}} - \frac{{V}_{L} * P}{P + {P}_{L}} \qquad ( 7 )$$

then the adsorbed gas recovery percent Rₐₚ corresponding to the formation pressure P is:

$${R}_{a p} = {G}_{p a} / {V}_{g i} \qquad ( 8 )$$

from the equations (6), (7) and (8):

$${R}_{a p} = \frac{\frac{{V}_{L} * {P}_{i}}{{P}_{i} + {P}_{L}} - \frac{{V}_{L} * P}{P + {P}_{L}}}{\frac{{V}_{L} * {P}_{i}}{{P}_{i} + {P}_{L}}} = 1 - \frac{P}{{P}_{i}} \frac{{P}_{i} + {P}_{L}}{P + {P}_{L}} \qquad ( 9 )$$

the equation (9) is the model for calculating the adsorbed gas recovery percent when the formation pressure is P;
a material balance equation for the free gas is:

$$\frac{P}{Z} = ( 1 - \frac{{G}_{P}}{{G}_{0}} ) \frac{{P}_{i}}{{Z}_{i}} \qquad ( 10 )$$

the free gas recovery percent R_{fp} when the formation pressure is P can be obtained from the equation (10):

$${R}_{fp} = \frac{{G}_{P}}{{G}_{0}} = 1 - \frac{{PZ}_{i}}{{P}_{i} Z} \qquad ( 11 )$$

making the free gas content under the original formation pressure and temperature conditions as G_{0f}, then the free gas production can be obtained according to the free gas recovery percent corresponding to the pressure P:

$${G}_{pf} = {G}_{0 f} * {R}_{fp} \qquad ( 12 )$$

from the equations (11) and (12):

$${G}_{pf} = {G}_{0 f} * ( 1 - \frac{{PZ}_{i}}{{P}_{i} Z} ) \qquad ( 13 )$$

making the adsorbed gas content under the original formation pressure and temperature conditions as G₀ₐ, then the adsorbed gas production can be obtained according to the adsorbed gas recovery percent corresponding to the pressure P:

$${G}_{pa} = {G}_{0 a} * {R}_{ap} \qquad ( 14 )$$

from the equations (9) and (14):

$${G}_{pa} = {G}_{0 a} * ( 1 - \frac{P}{{P}_{i}} \frac{{P}_{i} + {P}_{L}}{P + {P}_{L}} ) \qquad ( 15 )$$

from the equations (13) and (15), the total production of the free gas and the adsorbed gas corresponding to the pressure P is:

$${G}_{p} = {G}_{pf} + {G}_{pa} = {G}_{0 f} * ( 1 - \frac{{PZ}_{i}}{{P}_{i} Z} ) + {G}_{0 a} * ( 1 - \frac{P}{{P}_{i}} \frac{{P}_{i} + {P}_{L}}{P + {P}_{L}} ) \qquad ( 16 )$$

then the coalbed methane recovery percent at the pressure P is:

$${R}_{p} = {G}_{p} / ( {G}_{0 a} + {G}_{0 f} ) = \frac{{G}_{0 f} * ( 1 - \frac{{PZ}_{i}}{{P}_{i} Z} ) + {G}_{0 a} * ( 1 - \frac{P}{{P}_{i}} \times \frac{{P}_{i} + {P}_{L}}{P + {P}_{L}} )}{{G}_{0 a} + {G}_{0 f}} \qquad ( 17 )$$

the equation (17) is the expression for calculating the coalbed methane well recovery percent at any formation pressure P.

In the equations: Pᵢ: original formation pressure, MPa; V_{gi}: adsorbed gas volume under original formation pressure Pᵢ, m³/t; P: formation pressure, MPa; V_{g}: adsorbed gas volume when the formation pressure is P, m³/t; Gₚₐ: cumulative adsorbed gas production when the formation pressure is P, m³/t; Rₐₚ: adsorbed gas recovery percent corresponding to the formation pressure P, decimal; G_{pf}: cumulative free gas production when the pressure is P, m³/t; R_{fP}: free gas recovery percent corresponding to the formation pressure P, decimal; z: gas deviation factor corresponding to the formation pressure P, decimal; Zᵢ: gas deviation factor corresponding to the original formation pressure, decimal; G_{P}: cumulative production of natural gas, m³; G₀: original dynamic reserves of natural gas, m³; G_{0f}: free gas content under the original formation pressure and temperature, m³/t; G₀ₐ: adsorbed gas content under original formation pressure and temperature, m³/t; R_{P}: coalbed methane recovery percent under pressure P, decimal.

Preferably, principles for determining the production shares of the free gas and the adsorbed gas under any formation pressure conditions are as follows:
based on the PVT experimental parameters, the free gas recovery percent calculation model equation (11) is used to determine the free gas recovery percent R_{fp1} when the formation pressure is P+ΔP and the free gas recovery recovery percent R_{fp2} when the formation pressure is P−ΔP; assuming the formation pressure drops from P+ΔP down to P−ΔP in T days, then a cumulative free gas production of the coalbed methane well after the T days is G_{0f}*(R_{fp2}−R_{fp1}), and an average daily free gas production Q_{fp} of the coalbed methane well during the T days is:

$${Q}_{fp} = \frac{{G}_{0 f} * ( {R}_{fp 2} - {R}_{fp 1} )}{T} \qquad ( 18 )$$

wherein Q_{fp} is defined as the daily free gas production when the formation pressure is P if ΔP is sufficiently small;
based on the Langmuir pressure P_{L} and the Langmuir volume V_{L}, using the equation (9) to determine an adsorbed gas recovery Rₐₚ₁ when the formation pressure is P+ΔP and an adsorbed gas recovery percent Rₐₚ₂ when the formation pressure is P−ΔP; and assuming the formation pressure drops from P+ΔP down to P−ΔP in T days, then a cumulative adsorbed gas production of the coalbed methane well after the T days is G₀ₐ*(Rₐₚ₂−Rₐₚ₁), and an average daily adsorbed gas production Qₐₚ of the coalbed methane well during the T days is:

$${Q}_{ap} = \frac{{G}_{0 a} * ( {R}_{ap 2} - {R}_{ap 1} )}{T} \qquad ( 19 )$$

wherein Qₐₚ is defined as the daily adsorbed gas production when the formation pressure is P if ΔP is sufficiently small;
based on the daily free gas production Q_{fp} and the daily adsorbed gas production Qₐₚ when the formation pressure is P, the production share Per_{fp} of the free gas when the formation pressure is P can be calculated:

$${Per}_{fp} = \frac{{Q}_{fp}}{{Q}_{fp} + {Q}_{ap}} \qquad ( 20 )$$

from equations (18), (19) and (20):

$${Per}_{fp} = \frac{{G}_{0 f} * ( {R}_{fp 2} - {R}_{fp 1} )}{{G}_{0 f} * ( {R}_{fp 2} - {R}_{fp 1} ) + {G}_{0 a} * ( {R}_{ap 2} - {R}_{ap 1} )} \qquad ( 21 )$$

similarly, based on the daily free gas production Q_{fp} and the daily adsorbed gas production Qₐₚ when the formation pressure is P, the production share Perₐₚ of the adsorbed gas when the formation pressure is P can be calculated:

$${Per}_{ap} = \frac{{Q}_{ap}}{{Q}_{fp} + {Q}_{ap}} \qquad ( 22 )$$

from equations (18), (19) and (22):

$${Per}_{ap} = \frac{{G}_{0 a} * ( {R}_{a 2} - {R}_{a 1} )}{{G}_{0 f} * ( {R}_{f 2} - {R}_{f 1} ) + {G}_{0 a} * ( {R}_{a 2} - {R}_{a 1} )} \qquad ( 23 )$$

wherein: ΔP: sufficiently small change in formation pressure, MPa; R_{fp1}: free gas recovery percent when the formation pressure is P+ΔP, decimal; R_{fp2}: free gas recovery percent when the formation pressure is P−ΔP, decimal; Rₐₚ₁: adsorbed gas recovery percent when the formation pressure is P+ΔP, decimal; Rₐₚ₂: adsorbed gas recovery percent when the formation pressure is P−ΔP, decimal; T: time period that the formation pressure drops from P+ΔP down to P−ΔP, d; Q_{fp}: average daily free gas production of the coalbed methane well,

$$\frac{{m}^{3} / t}{d} ;$$

Qₐₚ: average daily adsorbed gas production of the coalbed methane well,

$$\frac{{m}^{3} / t}{d} ;$$

Per_{fp}: production share of the free gas when the formation pressure is P, decimals; Perₐₚ: production share of the adsorbed gas when the formation pressure is P, decimal.

Preferably, the technical solutions of the present invention will be illustrated below with specific embodiments. However, the protection scope of the present invention is not limited thereto.

### Embodiment 1

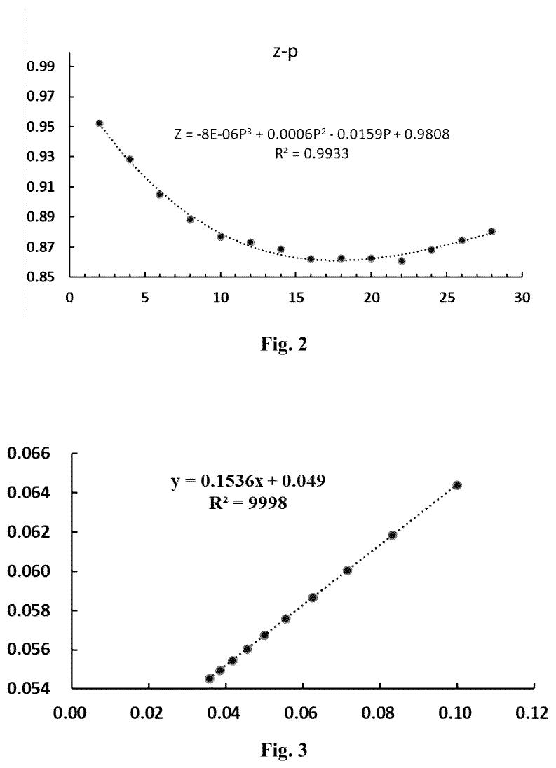

(1) The original formation pressure of a coalbed methane well was 28 MPa, and the relationship between pressure and deviation factor obtained based on the PVT sampling experimental analyzed data is shown in Table 1. Based on different pressures and corresponding deviation factors, an expression for calculating the deviation factor based on pressure can be obtained by function fitting (FIG. 2), which is Z=−8×10⁻⁶6P³+0.0006P²−0.0159P+0.9808.

TABLE 1
relationship between pressure and deviation factor

| Pressure P | Deviation Factor Z |
|---|---|
| (MPa) | (decimal) |
| 31 | 0.9133 |
| 28 | 0.8805 |
| 25 | 0.8716 |
| 22 | 0.8609 |
| 19 | 0.8631 |
| 16 | 0.8619 |
| 13 | 0.8715 |
| 10 | 0.8770 |
| 8.5 | 0.8843 |
| 6 | 0.9047 |
| 3 | 0.9405 |

(2) The collected isothermal adsorption experimental data of coalbed methane well are shown in Table 2. The adsorbed gas content under the original formation pressure and temperature conditions was G₀ₐ=18.34 m³/t, and that of free gas is G_{0f}=7.66 m³/t.

TABLE 2
coalbed methane isothermal adsorption
experimental data and observation data

| P | Vg | | |
|---|---|---|---|
| (MPa) | (m³/t) | y(i) = 1/Vg(i) | x(i) = 1/P(i) |
| 28 | 18.34 | 0.0545 | 0.0357 |
| 26 | 18.20 | 0.0549 | 0.0385 |
| 24 | 18.04 | 0.0554 | 0.0417 |
| 22 | 17.85 | 0.0560 | 0.0455 |
| 20 | 17.63 | 0.0567 | 0.0500 |
| 18 | 17.37 | 0.0576 | 0.0556 |
| 16 | 17.05 | 0.0587 | 0.0625 |
| 14 | 16.66 | 0.0600 | 0.0714 |
| 12 | 16.17 | 0.0618 | 0.0833 |
| 10 | 15.53 | 0.0644 | 0.1000 |
| 8 | 14.65 | 0.0683 | 0.1250 |
| 6 | 13.38 | 0.0747 | 0.1667 |
| 4 | 11.43 | 0.0875 | 0.2500 |
| 2 | 7.94 | 0.1259 | 0.5000 |

(3) According to the adsorption gas volumes V_{g(1)}, V_{g(2)}, . . . , V_{g(n)} corresponding to the different pressures P₍₁₎, P₍₂₎, . . . , P₍ₙ₎ under the coalbed methane well formation temperature conditions, it was introduced that

$${y}_{( i )} = \frac{1}{{V}_{g ( i )}} ,$$

x₍ᵢ₎=P₍ᵢ₎, i=1,2, . . . , n, so as to get a series of observation points (y₍ᵢ₎, x₍ᵢ₎) (Table 2). The observation points were processed with linear fit (FIG. 3), wherein the Langmuir volume V_{L} is equal to an inverse of an intercept of a fitted linear equation, i.e.

$${V}_{L} = \frac{1}{0.049} = 20.4 \; 082 {m}^{3} / t ,$$

and the Langmuir pressure P_{L} is equal to a slope of the fitted linear equation divided by the intercept of the fitted linear equation, i.e.

$${P}_{L} = \frac{0.1536}{0.049} = 3.1347 MPa .$$

(4) When the formation pressure P=26 MPa and the formation pressure variation ΔP=0.005 MPa, firstly, according to the data table of the relationship between pressure and deviation factor (Table 1), it can be found that the deviation factor corresponding to the original formation pressure Pᵢ=28 MPa is Zᵢ=0.8805. The deviation factor calculation expression Z=−8×10−⁶6P³+0.0006P²−0.0159P+0.9808 in the Step (1) was adopted to calculate the deviation factor Z₁=0.832387 corresponding to the formation pressure P+ΔP=26.005 MPa and the deviation factor Z₂=0.832397 corresponding to the formation pressure P−ΔP=25.995 MPa. The model R_{fp}=1−(P/Z)/(Pᵢ/Zᵢ) was used to determine the free gas recovery percent R_{fp1}=1−(26.005/0.832387)/(28/0.8805)=0.017567 when the formation pressure is P+ΔP=26.005 MPa and the free gas recovery percent R_{fp2}=1−(25.995/0.832397)/(28/0.8805)=0.017957 when the formation pressure is P−ΔP=25.995 MPa. It took T days for the formation pressure to drop from P+ΔP down to P−ΔP, wherein the cumulative free gas production of the coalbed methane well during this period was G_{0f}*(R_{fp2}−R_{fp1})=7.66*(0.017957-0.017567)=0.002987 m³/t, and the average daily free gas production of the coalbed methane well was

$${Q}_{fp} = {G}_{0 f} * \frac{{R}_{f p 2} - {R}_{f p 1}}{T} = \frac{0.002987}{T} \frac{{m}^{3} / t}{d} .$$

Since ΔP=0.005 MPa was very small, it can be approximated that the daily free gas production was

$${Q}_{f p} = \frac{0.002987}{T} \frac{{m}^{3} / t}{d}$$

when the formation pressure was equal to 26 MPa.
(5) Based on the Langmuir pressure P_{L}=3.1347 MPa and the Langmuir volume V_{L}=20.4082 m³/t obtained in the Step (3), a model Rₐₚ−(P/Pᵢ)*(Pᵢ+P_{L})/(P+P_{L}) was adopted to determine the adsorbed gas recovery percent Rₐₚ₁=1−[(P+ΔP)/Pᵢ]*(Pᵢ+P_{L})/[(P+ΔP)+P_{L}]=1−(26.005/28)*(28+3.1347)/(26.005+3.1347)=0.007665 when the formation pressure was P+ΔP=26.005 MPa and the adsorbed gas recovery percent Rₐₚ₂−1−[(P−ΔP)/Pᵢ]*(Pᵢ+P_{L})/[(P−ΔP)+P_{L}]=1−(25.995/28)*(28+3.1347)/(25.995+3.1347)=0.007706 when the formation pressure was P−ΔP=25.995 MPa. It took T days for the formation pressure to drop from P+ΔP=26.005 MPa down to P−ΔP=25.995 MPa, wherein the cumulative adsorbed gas production of the coalbed methane well during this period was G₀ₐ*(Rₐₚ₂−Rₐₚ₁)=18.34*(0.007706−0.007665)=0.000752 m³/t, and the average daily adsorbed gas production of the coalbed methane well was

$${Q}_{a p} = {G}_{0 a} * \frac{{R}_{a 2} - {R}_{a 1}}{T} = \frac{0.000752}{T} {m}^{3} / t .$$

Since ΔP=0.005 MPa was very small, it can be approximated that the daily adsorbed gas production was

$${Q}_{a p} = \frac{0.000752}{T} \frac{{m}^{3} / t}{d}$$

when the formation pressure was equal to 26 MPa.
(6) Based on the original formation pressure Pᵢ and the PVT experimental parameters obtained in the Step (1), the deviation factor under a pressure of 26 MPa was firstly determined as Z=0.083239 according to the deviation factor calculation expression Z=−8×10⁻⁶6P³+0.0006P²−0.0159P+0.9808 in the Step (1). Based on the free gas content G_{0f}=7.66 m³/t and the adsorbed gas content G₀ₐ=18.34 m³/t under the original formation pressure and temperature conditions obtained in the Step (2), the Langmuir pressure P_{L}=3.1347 MPa obtained in the Step (3), and the deviation factor Zᵢ=0.8805 corresponding to the original formation pressure Pᵢ=28 MPa obtained in the Step (4), the model

$${R}_{P} = \frac{{G}_{0 f} * ( 1 - \frac{P {Z}_{i}}{{P}_{i} Z} ) + {G}_{0 a} * ( 1 - \frac{P}{{P}_{i}} \times \frac{{P}_{i} + {P}_{L}}{P + {P}_{L}} )}{{G}_{0 a} + {G}_{0 f}}$$

was used to calculate the coalbed methane well recovery percent when the formation pressure is P, which is

$${R}_{P} = \frac{( 7.66 * ( 1 - \frac{26 * 0.8805}{28 * 0.83239} ) + 18.34 * ( 1 - \frac{26}{28} * \frac{28 + 3.1347}{26 + 3.1347} ) )}{18.34 + 7.66} = 0.01065 .$$

(7) Based on the daily free gas production

$${Q}_{f p} = \frac{0.002987}{T} \frac{{m}^{3} / t}{d}$$

obtained in the Step (4) when the formation pressure was P and the daily adsorbed gas production

$${Q}_{a p} = \frac{0.000 \; 752}{T} \frac{{m}^{3} / t}{d}$$

obtained in the Step (5) when the formation pressure was P, the production share of the free gas when the formation pressure is P can be calculated as

$$\frac{{Q}_{f p}}{{Q}_{f p} + {Q}_{a p}} = \frac{\frac{0.002987}{T}}{\frac{0.002987}{T} + \frac{0.000752}{T}} = 0.79888 ,$$

and the production share of the adsorbed gas production when the formation pressure is P can be calculated as

$$\frac{{Q}_{a p}}{{Q}_{f p} + {Q}_{a p}} = \frac{\frac{0.000752}{T}}{\frac{0.002987}{T} + \frac{0.000752}{T}} = 0.2011 2 .$$

(8) The steps (1)-(7) were repeated with different formation pressures P=26, 24, 22, 20, . . . , 2 MPa, so as to obtain the production shares of the free gas and the adsorbed gas under different formation pressures (Table 3);

TABLE 3
production shares of the free gas and the adsorbed
gas under different pressures and recovery percent

| | Production | Production | |
|---|---|---|---|
| | Share of | Share of | Recovery |
| Pressure | Free Gas | Adsorbed Gas | Percent |
| P | Perfp | PeraP | Rp |
| (MPa) | (decimal) | (decimal) | (decimal) |
| 26 | 0.7981 | 0.2019 | 0.0107 |
| 24 | 0.7735 | 0.2265 | 0.0397 |
| 22 | 0.7456 | 0.2544 | 0.0697 |
| 20 | 0.7135 | 0.2865 | 0.1010 |
| 18 | 0.6760 | 0.3240 | 0.1340 |
| 16 | 0.6318 | 0.3682 | 0.1692 |
| 14 | 0.5792 | 0.4208 | 0.2072 |
| 12 | 0.5168 | 0.4832 | 0.2492 |
| 10 | 0.4437 | 0.5563 | 0.2968 |
| 8 | 0.3603 | 0.6397 | 0.3530 |
| 6 | 0.2697 | 0.7303 | 0.4234 |
| 4 | 0.1785 | 0.8215 | 0.5203 |
| 2 | 0.0970 | 0.9030 | 0.6750 |

(9) According to the production shares of the free gas and the adsorbed gas under different formation pressure conditions obtained in the Step (8) (Table 3), as well as the coalbed methane recovery percent R_{P} obtained in the Step (6) when the formation pressure was P, the production shares of the free gas and the adsorbed gas under different recovery percent can be obtained (Table 3).

The above is a preferred embodiment of the present invention, which is not intended to be limiting. Any other modifications not deviating from the present invention shall be equivalent replacements, and shall be included in the protection scope of the present invention.

What is claimed is:

1. A method for determining production shares of free gas and adsorbed gas in deep coalbed methane well mining, comprising steps of:
Step 1: collecting an original formation pressure Pᵢ and PVT sampling experimental analysis data of a target coalbed methane well, so as to obtain deviation factors corresponding to different pressures under coalbed methane well formation temperature conditions;
Step 2: collecting isothermal adsorption experimental data carried out on deep coal rocks, as well as adsorbed gas content G₀ₐ and free gas content G_{0f} under the original formation pressure and the temperature conditions;
Step 3: determining a Langmuir pressure P_{L} and a Langmuir volume V_{L} based on the isothermal adsorption experimental data;
Step 4: determining a daily production Q_{fp} of the free gas when the formation pressure is P;
Step 5: determining a daily production Qₐₚ of the adsorbed gas when the formation pressure is P;
Step 6: determining a coalbed methane recovery percent R_{P} when the formation pressure is P;
Step 7: based on the daily production Q_{fp} of the free gas obtained in the Step 4 when the formation pressure is P and the daily production Qₐₚ of the adsorbed gas obtained in the Step 5 when the formation pressure is P, calculating a production share Q_{fp}/(Q_{fp}+Qₐₚ) of the free gas when the formation pressure is P as well as a production share Qₐₚ/(Q_{fp}+Qₐₚ) of the adsorbed gas when the formation pressure is P;
Step 8: obtaining different formation pressures P, and repeating the Steps 1-7, thereby obtaining the production shares of the free gas and the adsorbed gas under the different formation pressures; and
Step 9: based on the production shares of the free gas and the adsorbed gas under the different formation pressures obtained in the Step 8, as well as the coalbed methane recovery percent R_{P} obtained in the Step 6 when the formation pressure is P, obtaining the production shares of the free gas and the adsorbed gas under different recovery percent.

2. The method, as recited in claim 1, wherein in the Step 3, the Langmuir pressure P_{L} and the Langmuir volume V_{L} are determined by steps of:
introducing
$${y}_{( i )} = \frac{1}{{V}_{g ( i )}}$$
and x₍ᵢ₎=P₍ᵢ₎, i=1,2, . . . , n; according to adsorption gas volumes V_{g(1)}, V_{g(2)}, . . . , V_{g(n)} corresponding to the different pressures P₍ᵢ₎, P₍₂₎, . . . , P₍ₙ₎ under the coalbed methane well formation temperature conditions, obtaining a series of observation points (y₍ᵢ₎, x₍ᵢ₎); and processing the observation points with linear fit, wherein the Langmuir volume V_{L} is equal to an inverse of an intercept of a fitted linear equation, and the Langmuir pressure P_{L} is equal to a slope of the fitted linear equation divided by the intercept of the fitted linear equation.

3. The method, as recited in claim 1, wherein in the Step 4, the daily production Q_{fp} of the free gas when the formation pressure is P is obtained by steps of:
based on the PVT sampling experimental analysis data obtained in the Step 1, using a model R_{fp}=1−(P/Z)/(Pᵢ/Zᵢ) to determine a free gas recovery percent R_{fp1} when the formation pressure is P+ΔP and a free gas recovery percent R_{fp2} when the formation pressure is P−ΔP; and
assuming the formation pressure drops from P+ΔP down to P−ΔP in T days, then a cumulative free gas production of the coalbed methane well after the T days is G_{0f}*(R_{fp2}−R_{fp1}), and an average daily free gas production of the coalbed methane well during the T days is Q_{fp}=G_{0f}*(R_{fp2}−R_{fp1})/T; wherein Q_{fp} is defined as the daily free gas production when the formation pressure is P if ΔP is sufficiently small.

4. The method, as recited in claim 1, wherein in the Step 5, the daily production Qₐₚ of the adsorbed gas when the formation pressure is P is obtained by steps of:
based on the Langmuir pressure P_{L} and the Langmuir volume V_{L} obtained in the Step 3, using a model Rₐₚ−1−(P/Pᵢ)*(Pᵢ+P_{L})/(P_{L}+P_{L}) to determine an adsorbed gas recovery percent Rₐₚ₁ when the formation pressure is P+ΔP and an adsorbed gas recovery percent Rₐₚ₂ when the formation pressure is P−ΔP; and
assuming the formation pressure drops from P+ΔP down to P−ΔP in T days, then a cumulative adsorbed gas production of the coalbed methane well after the T days is G₀ₐ*(Rₐₚ₂−Rₐₚ₁), and an average daily adsorbed gas production of the coalbed methane well during the T days is Qₐₚ=G₀ₐ*(Ra₂−Rₐ₁)/T; wherein Qₐₚ is defined as the daily adsorbed gas production when the formation pressure is P if ΔP is sufficiently small.

5. The method, as recited in claim 1, wherein in the Step 6, the coalbed methane recovery percent R_{P} when the formation pressure is P is obtained by steps of:
based on the PVT sampling experimental analysis data obtained in the Step 1, using a model R_{fp}=1−(P/Z)/(Pᵢ/Zᵢ) to determine a free gas recovery percent R_{fp1} when the formation pressure is P; based on the free gas content G_{0f} obtained in the Step 2 under the original formation pressure and the temperature conditions, obtaining a cumulative free gas production G_{0f}×R_{fP} when the formation pressure is P; and
based on the Langmuir pressure P_{L} and the Langmuir volume V_{L} obtained in the Step 3, using a model Rₐₚ=1−(P/Pᵢ)*(Pᵢ+P_{L})/(P_{L}+P_{L}) to determine an adsorbed gas recovery percent Rₐₚ when the formation pressure is P; based on the adsorbed gas content G₀ₐ obtained in the Step 2 under the original formation pressure and the temperature conditions, obtaining a cumulative adsorbed gas production G₀ₐ×Rₐₚ when the formation pressure is P;
wherein when the formation pressure is P, a total production of the free gas and the adsorbed gas is G_{0f}×R_{fP}+G₀ₐ×Rₐₚ, then the coalbed methane recovery percent R_{P} corresponding to the formation pressure P is calculated as
$${R}_{P} = ( {G}_{0 f} \times {R}_{f P} + {G}_{0 a} \times {R}_{a p} ) / ( {G}_{0 f} + {G}_{0 a} ) , equaling to {R}_{p} = \frac{{G}_{0 f} * ( 1 - \frac{P {Z}_{i}}{{P}_{i} Z} ) + {G}_{0 a} * ( 1 - \frac{P}{{P}_{i}} \times \frac{{P}_{i} + {P}_{L}}{P + {P}_{L}} )}{{G}_{0 a} + {G}_{0 f}} .$$
